(19) United States
(12) Patent Application Publication
(10) Pub. No.: US 2007/0142561 A1
(43) Pub. Date: Jun. 21, 2007

(54) Graft rubbers having improved stability to degradation by thermal oxidation

(75) Inventors: Herbert Eichenauer, Dormagen (DE); Ulrich Jansen, Dormagen (DE)

Correspondence Address: LANXESS CORPORATION, 111 RIDC PARK WEST DRIVE, PITTSBURGH, PA, 15275-1112, US

(73) Assignee: LANXESS Deutschland GmbH

(21) Appl. No.: 11/638,983

(22) Filed: Dec. 14, 2006

(30) Foreign Application Priority Data
Dec. 20, 2005 (DE) 10 2005 060 827.2

(51) Int. Cl. C08F 297/02

(52) U.S. Cl. 525/242

(57) ABSTRACT

Graft rubbers stabilized to degradation by thermal oxidation contain at least one phenolic compound and a synergistic compound.

The invention relates to stabilized graft rubbers, their preparation and use.

Graft rubbers, i.e. products prepared by graft polymerization of vinyl monomers in the presence of rubber, are used as agents for improving the impact strength in numerous thermoplastic systems.

Those graft rubbers which are obtained by polymerization of styrene and acrylonitrile, optionally in combination with further vinyl monomers, such as, for example, α-methylstyrene or methyl methacrylate, in the presence of butadiene rubbers by emulsion polymerization have proved particularly widely usable in various types of thermoplastic resins.

Examples of the preparation of such graft rubbers and the use thereof for impact modification are described in EP-A 253 236 and EP-A 818 480 (ABS polymers), EP-A 402 748 (PVC), EP-A 315 868 (polycarbonate), DE-A 102 55 824 (polycarbonate/ABS blend systems).

In the conversion of the graft rubbers prepared by emulsion polymerization from the latex form into the solid form, the removal of the water with the use of kneader reactors with direct formation of graft rubber/resin polymer mixtures (cf. EP-A 768 157, EP-A 867 463 and the literature cited there) has also proved useful in addition to the drying to give graft rubber powder, for example by means of fluid-bed dryers, fluidized-bed dryers or pneumatic dryers.

However, the problem that the level of sensitivity to degradation by thermal oxidation for graft rubber powder and material containing graft rubber prepared by working up in a kneader reactor may be different, (in particular in the case of graft rubbers having rubber contents of over 50% by weight) occurs here. This is evident, for example, from a different tendency to discoloration, under thermal load, of the graft rubbers dried on different units, with the result that the flexibility in the case of changing or alternative use of the various units used for drying the moist graft rubber is very greatly limited. Although stabilizers or stabilizer systems for ABS polymers and also ABS graft rubbers are described in the literature, none of these systems leads to a solution to said problem.

Thus, for example, EP 915 130 A1 describes the stabilization of ABS polymers by a combination of a sterically hindered phenol, thioester and phosphite. However, this system is suitable only for stabilizing dry granules, hydrolysis of the phosphite taking place in the presence of water. Incorporation into an aqueous emulsion is therefore not possible.

Furthermore, WO 01/92391 A1 describes the stabilization of thermoplastic ABS moulded materials with the use of a combination of a special sterically hindered phenol, thioester, special three-block copolymers and alkali metal or alkaline earth metal salts of carboxylic acids.

Incorporation of this complex mixture into an aqueous emulsion is difficult and does not lead to the solution to the problem since, for example, no graft rubbers for applications in materials sensitive to alkaline compounds (e.g. polycarbonate, polycarbonate/ABS blends) can be prepared in this manner.

It was an object of the present invention to provide graft rubbers which, independently of the drying method used have a high stability to degradation by thermal oxidation.

The invention relates to graft rubbers stabilized to degradation by thermal oxidation, in particular during drying by fluid-bed dryers, fluidized-bed dryers, pneumatic dryers or kneader reactors, characterized in that they contain
a) at least one phenolic compound A) having at least one structural unit of the general formula I 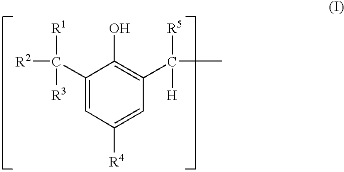
   where
   R¹, R², R³, R⁴ are identical or different and are an optionally substituted hydrocarbon radical having 1 to 20 carbon atoms,
   R⁵ is an optionally substituted hydrocarbon radical having 1 to 20 carbon atoms or, together with the radical of compound A, form an optionally substituted carbocyclic radical and
b) at least one sulphur-containing synergistic agent B) obtainable by polymerization of optionally substituted styrene with optionally substituted acrylonitrile and a mercaptan HSR⁶; preferably a compound B) having at least one structural unit of the general formula II 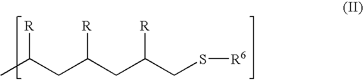
   where
   R are identical or different and are C6H₅, —CN or a substituted aryl radical
   R⁶ are identical or different and are an optionally substituted hydrocarbon radical having 1 to 20 carbon atoms.

In a preferred embodiment, the graft rubbers according to the invention also contain a small amount of a phenolic compound A1) having at least one structural unit of the general formula (III) 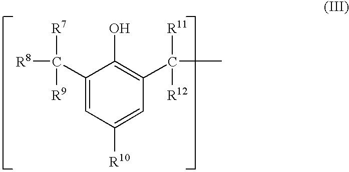
where
R⁷, R⁸, R⁹, R¹¹, R¹² are identical or different and are an optionally substituted hydrocarbon radical having 1 to 20 carbon atoms,
R¹⁰ is an organic radical, preferably a hydrocarbon radical having 1 to 10 carbon atoms.

In the context of the invention, a small amount means that the amount of A1) is in general 5 to 30% by weight, preferably 10 to 25% by weight (based in each case on the amount by weight of A).

The present invention furthermore relates to thermoplastic moulding materials containing said graft rubbers.

The present invention furthermore relates to a process for the preparation of dried graft rubbers stabilized to degradation by thermal oxidation, characterized in that a compound A) present in aqueous emulsion or dispersion form and a sulphur-containing synergistic agent B obtainable by polymerization of optionally substituted styrene with optionally substituted acrylonitrile and a mercaptan HSR⁶, R⁶ having the abovementioned meaning, preferably a compound B) present as an aqueous emulsion, are added to the graft rubber present in emulsion form, before the working-up and drying with stirring.

The two components A) and B) are preferably added independently of one another to the emulsion of the graft rubber to be stabilized and are stirred in; preferably, first the emulsion or dispersion of the compound A) is added and stirred in and then the emulsion of the compound B) is added and stirred in.

The amounts of A) used are as a rule 0.1 to 1 part by weight, preferably 0.2 to 0.8 part by weight and particularly preferably 0.25 to 0.7 part by weight (based in each case on 100 parts by weight of graft rubber).

The amounts of B) used are as a rule 0.5 to 5 parts by weight, preferably 1 to 4 parts by weight and particularly preferably 1.5 to 3.5 parts by weight (based in each case on 100 parts by weight of graft rubber).

Graft rubbers used according to the invention are products which were obtained by emulsion polymerization of mixtures of styrene and acrylonitrile and optionally further monomers in the presence of rubbers present in emulsion form.

Suitable rubbers are rubbers present in emulsion form and having glass transition temperatures of≦10° C. Preferred rubbers are polymers of butadiene, for example polybutadiene, butadiene/styrene copolymers, preferably having styrene contents of 3 to 40% by weight, butadiene/acrylonitrile copolymers, preferably having acrylonitrile contents of 3 to 20% by weight, terpolymers of butadiene, styrene and acrylonitrile, copolymers and terpolymers of butadiene with other vinyl monomers, such as, for example, acrylic acid, methacrylic acid, vinylpyridine, C₁₋₈-acrylic esters, such as, for example, n-butyl acrylate or 2-ethylhexyl acrylate, C₁₋₈-methacrylic esters, such as, for example, methyl methacrylate.

Preferred rubbers are polybutadiene, butadiene/styrene copolymers and butadiene/acrylonitrile copolymers.

For the preparation of the graft rubbers to be used according to the invention, the rubber is expediently present in emulsion form. The rubber lattices used for the preparation of the graft rubbers have, as a rule, median particle diameters of 50 to 1000 nm, preferably 80 to 800 nm and particularly preferably 100 to 600 nm. Monomodal, bimodal, trimodal and multimodal rubber lattices may be used.

The median particle diameters are determined by means of an ultracentrifuge (cf. W. Scholtan, H. Lange: Kolloid Z. u. Z. Polymere 250, pages 782 to 796 (1972)).

The gel contents of the rubbers are in general at least 30% by weight, preferably at least 40% by weight, (measured in toluene by the wire cage method, cf. Houben-Weyl, Methoden der Organischen Chemie, Makromolekulare Stoffe [Methods of Organic Chemistry, Macromolecular Substances], part 1, page 307 (1961), Thieme Verlag Stuttgart).

Suitable vinyl monomers for synthesizing the graft shell of the graft rubbers to be used according to the invention are in principle monomers which can be polymerized in aqueous emulsion in the presence of a rubber latex. Vinylaromatics, such as, for example, styrene or α-methylstyrene, in combination with unsaturated nitriles, such as, for example, acrylonitrile or methacrylonitrile, are preferably used. Further monomers, such as, for example, C₁₋₈-acrylic esters and C₁₋₈-methacrylic esters, e.g. n-butyl acrylate, tert-butyl acrylate or methyl methacrylate, or N-substituted maleimides, e.g. N-phenylmaleimide, can be used in proportions in addition to the vinyl aromatic and unsaturated nitrile.

Particularly preferred vinyl monomers are mixtures of styrene and acrylonitrile, preferably in the weight ratio of 90:10 to 50:50, particularly preferably in the weight ratio of 65:35 to 80:20.

The preparation of the graft rubbers to be used according to the invention can be carried out in such a way that the monomer mixture is continuously added to the respective rubber latex and polymerized. In addition to the monomers, the molecular weight regulators can be used in the graft polymerization, preferably in amounts of 0.05 to 2% by weight. Suitable molecular weight regulators are, for example, alkyl mercaptans, such as n-dodecyl mercaptan or t-dodecyl mercaptan, dimeric α-methylstyrene or terpinolene.

Suitable initiators are inorganic and organic peroxides, e.g. H₂O₂, di-tert-butyl peroxide, cumyl hydroperoxide, dicyclohexyl percarbonate, tert-butyl hydroperoxide, p-menthane hydroperoxide, azo initiators, such as, for example, azobisisobutyronitrile, inorganic per salts, such as ammonium, sodium or potassium persulphate, potassium perphosphate or sodium perborate, and redox systems which are composed of a generally organic oxidizing agent and a reducing agent, it being possible for heavy metal ions additionally to be present in the reaction medium (cf. Houben-Weyl, Methoden der Organischen Chemie [Methods for Organic Chemistry], volume 14/1, pages 263 to 297).

The polymerization temperature is 25° C. to 160° C., preferably 40° C. to 90° C. Suitable emulsifiers are the customary anionic emulsifiers, such as alkylsulphates, alkanesulphonates, aralkylsulphonates, soaps of saturated or unsaturated fatty acids and alkaline disproportionated or hydrogenated abietic or tall oil acids. Emulsifiers having carboxyl groups (e.g. salts of C₁₀-C₁₈-fatty acids, disproportionated abeitic acid, emulsifiers according to DE-A 36 39 904 and DE-A 39 13 509) are preferably used.

The graft rubbers to be used according to the invention have a rubber content of 10 to 90% by weight, preferably of 30 to 80% by weight and particularly preferably of 50 to 75% by weight.

The phenolic compounds A) to be used according to the invention and having a special composition have a molecular weight of more than 400, preferably 600 to 1000. Such compounds are known in principle. Examples are, for example, the phenols on the market under the names Wingstay® L (Eliokem), Lowinox® CPL (Great Lakes), Ralox® LC (Degussa), Anox® 29 (Great Lakes).

Particularly preferably used is the compound

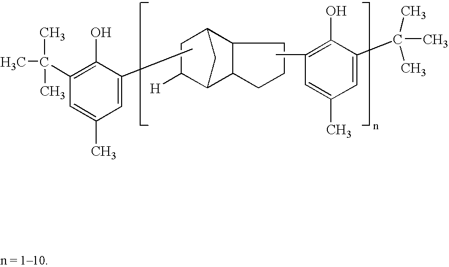

The compounds A1) optionally additionally to be used according to the invention in a small amount have a molecular weight of more than 400, preferably 500 to 1200. Such compounds are known in principle.

Examples are Irganox® 1076 (Ciba), Anox® PP 18 (Great Lakes), Irganox® 1010 (Ciba), Anox® PP 20 (Great Lakes), Irganox® 259 (Ciba).

The conversion of the compound A) and optionally of the compound A1) into an aqueous emulsion or dispersion form, can be effected, for example, with generation of strong shear forces in jet dispersers or with the use of Ultraturrax® apparatuses in the presence of aqueous surfactant solutions.

Suitable aqueous surfactants are, for example, solutions of anionic or non-ionic emulsifiers. Examples of such compounds are alkali metal salts of fatty acids, alkali metal salts of resin acids, alkali metal salts of sulphosuccinic acid, alkali metal salts of alkanesulphonic acids or aralkyl sulphonic acids, ethoxylated fatty alcohols, ethoxylated alkyl phenols.

The sulphur-containing compound B) to be used according to the invention is preferably obtained by emulsion polymerization of vinyl monomers, preferably of mixtures of styrene and acrylonitrile in the weight ratio of 90:10 to 60:40, preferably 80:20 to 70:30, in the presence of mercaptans.

The compounds B) to be used according to the invention have a sulphur content of 1 to 4% by weight, preferably of 1 to 3% by weight.

The preparation of such compounds is known in principle and is described, for example, in European Patent 195 918. Since an aqueous emulsion is obtained directly by the preparation of B) by means of emulsion polymerization, the compound B) can be used in this form without further treatment.

The addition of the components A), optionally A1) and B) to the graft rubber emulsions is usually effected prior to the working-up, a homogeneous distribution being ensured. Preferably, first A) (and optionally A1)) is added and homogeneously distributed in the graft rubber latex and then B) is added and homogeneously distributed.

In principle it is also possible to mix A) and optionally A1) and B) prior to the addition or to add A) and optionally A1) and B) simultaneously and to distribute them homogeneously.

The working-up of the graft rubber latex mixed with A), and optionally A1) and B) is preferably effected by coagulation after addition of electrolytes. The use of salt solutions (e.g. aqueous solutions of magnesium sulphate, sodium sulphate, aluminium sulphate, sodium chloride or calcium chloride), acids (e.g. acetic acid, sulphuric acid or phosphoric acid) or combinations thereof is preferred here.

The mixture of water and graft rubber suspended therein, which is present after the coagulation, is usually separated by filtration, pressing out or centrifuging, after which the moist graft rubber is freed from the water still present by treatment in dryers, (e.g. fluid-bed dryer, fluidized-bed dryer, pneumatic dryer, kneader reactors). During the drying in kneader reactors, simultaneous mixing with resin polymers is usually effected (cf. in this context EP-A 768 157 and EP-A 867 463). During the drying of the graft rubbers according to the invention in kneader reactors, mixing with styrene/acrylonitrile copolymers is preferably effected, particularly preferably with styrene/acrylonitrile copolymers composed of 50 to 95% by weight of styrene and 5 to 50% by weight of acrylonitrile, preferably of 65 to 85% by weight of styrene and 15 to 35% by weight of acrylonitrile.

These copolymers preferably have average molecular weights M̅_{W} of 20 000 to 200 000 or intrinsic viscosities [η] of 20 to 110 ml/g (measured in dimethylformamide at 25° C.).

Details of the preparation of these resins are described, for example, in DE-B 2 420 358 and DE-B 2 724 360. Resin polymers prepared by mass or solution polymerization have proved particularly useful. The copolymers can be added on their own or in any desired mixture.

The resulting anhydrous graft rubber products are suitable for the impact modification of polymers and, for this purpose, can be mixed with further polymer components, preferably selected from styrene/acrylonitrile copolymers, α-methylstyrene/acrylonitrile copolymers, aromatic polycarbonates, aromatic polyester carbonates, polyesters, polyamide and PVC.

### EXAMPLES

The invention is explained in more detail in the following examples. The stated parts are parts by weight and always relate to solid constituents or polymerizable constituents.

The following substances were used in carrying out the experiments described below:

Graft Rubber Latex 1

A polymer obtained by emulsion polymerization of 40 parts by weight of a styrene/acrylonitrile mixture (weight ratio 73:27) in the presence of 60 parts of a polybutadiene latex having a median particle size d₅₀ of 345 nm (using a redox initiator system comprising sodium ascorbate and tert-butyl hydroperoxide) was used as graft rubber 1.

Graft Rubber Latex 2

A mixture of a first graft rubber latex (obtained by emulsion polymerization of 50 parts by weight of a styrene/acrylonitrile mixture in the weight ratio of 73:27 in the presence of 50 parts by weight of a polybutadiene latex having a median particle size d₅₀ of 125 nm (using potassium peroxodisulphate as initiator)) and a second graft rubber latex (obtained by emulsion polymerization of 41 parts by weight of a styrene/acrylonitrile mixture in the weight ratio of 73:27 in the presence of 59 parts by weight of a polybutadiene latex having a median particle size d₅₀ of 345 nm (using potassium peroxodisulphate as an initiator)) was used as graft rubber 2, the weight ratio of the two graft rubbers being 1:1.

Styrene/Acrylonitrile Copolymer (SAN Resin)

Random copolymer (styrene:acrylonitrile weight ratio=72:28) obtained by free radical solution polymerization and having an average molecular weight M̅_{w} of about 85 000 and a molecular nonuniformity M̅_{w}/ M̅ₙ −1 of ≦2.

The following stabilizers were added to the graft rubbers as stated in table 1, the content of active groups added by the added stabilizers being kept constant in each case (sterically hindered OH group 0.024%, sulphur content 0.047%).

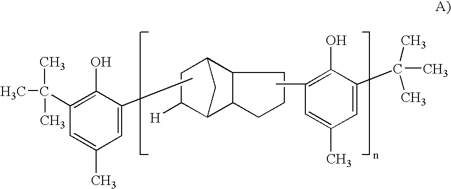

Wingstay® L from Eliochem, France 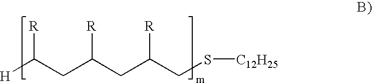
prepared by emulsion polymerization of styrene, acrylonitrile and tert-dodecyl mercaptan according to EP-B 195 918, example 1.
C) Octadecyl-3-(3,5-di-tert-butyl-4-hydroxyphenyl) propionate (Irganox® 1076), Ciba, Basel, Switzerland).
D) Dilauryl thiodipropionate (Irganox® PS 800), Ciba, Basel, Switzerland). (synergistic agent not according to the invention)

The incorporation of the stabilizers was effected by addition of the substances present in the form of separate aqueous dispersions or aqueous emulsions to the graft rubber lattices.

The respective dispersions or emulsions are added individually (first A and then B) to the graft rubber latex and homogeneously distributed in each case by stirring.

The working-up was effected in each case by precipitation with a 1:1 mixture of magnesium sulphate and acetic acid in the form of a 1% strength aqueous solution; the subsequent washing was carried out with water. After the removal of the predominant portion of water by filtration, pressing out and centrifuging, the moist powders then present were mixed with the melt of the styrene/acrylonitrile copolymer described above analogously to example 1 of EP-B 867 463 in a kneader reactor and dried (drying K in table 1).

At the same time, the moist powders of the coagulated graft rubbers were dried in a forced circulation drying oven at 70° C. (simulation of powder drying, drying P in table 1).

The measurement of the thermal stability of the graft rubbers present in powder form was effected by determination of the oxidative discoloration with the use of a Metrastat test system PSD 260 (manufacturer: PSD-Prüfgerate-Systeme Dr. Stapfer GmbH, Düsseldorf). At a predetermined temperature, the graft rubber powder is stored under air and the time until discoloration occurs is determined. This represents a simulation of the thermal load during the drying process. The determination of the stability of the graft rubbers was effected by determination of the time after which a brown discoloration occurred at 180° C.).

The determination of the thermal stability of the products obtained after drying in the kneader reactor was effected by measurement of the colour in the uncoloured state on the resulting product (yellowness index, YI according to ASTM standard D 1925 (illuminant: C, observer 2°, measuring orifice: large area value according to the equation YI=(128X−106Z/Y), where X, Y, Z=colour coordinates according to DIN 5033.

The corresponding values for the thermal stabilities after drying (time up to brown coloration in the Metrostat test or YI on drying in the kneader reactor) are likewise stated in table 1.

From the values, it is evident that only the graft rubbers stabilized according to the invention have a good stability to degradation by thermal oxidation, both on drying to give graft rubber powder and on drying in the kneader reactor to give a graft rubber/resin polymer mixture.

TABLE 1

| | | | | | | | | | Metrastat test | |
|---|---|---|---|---|---|---|---|---|---|---|
| | | | | | | | | | (time up to | |
| | Graft | Graft | | | | | | | incipient brown | |
| Example | rubber 1 | rubber 2 | SAN resin | Stabilizer A | Stabilizer B | Stabilizer C | Stabilizer D | Drying | colour in min) | YI |
| 1 | 100 | — | — | X | X | — | — | P | 350 | — |
| 2 | 100 | — | — | X (80%) | X | — | X (20%) | P | 390 | — |
| 3 (Comparison) | 100 | — | — | X | — | — | X | P | 240 | — |
| 4 (Comparison) | 100 | — | — | — | X | X | — | P | 160 | — |
| 5 (Comparison) | 100 | — | — | — | — | X | X | P | 120 | — |
| 6 | 75 | — | 25 | X | X | — | — | K | — | 23 |
| 7 | 75 | — | 25 | X (80%) | X | — | X (20%) | K | — | 22 |
| 8 (Comparison) | 75 | — | 25 | X | — | — | X | K | — | 31 |
| 9 (Comparison) | 75 | — | 25 | — | X | X | — | K | — | 25 |
| 10 (Comparison) | 75 | — | 25 | — | — | X | X | K | — | 32 |
| 11 | — | 100 | — | X | X | — | — | P | 380 | — |
| 12 | — | 100 | — | X (80%) | X | — | X (20%) | P | 400 | — |
| 13 (Comparison) | — | 100 | — | X | — | — | X | P | 340 | — |
| 14 (Comparison) | — | 100 | — | — | X | X | — | P | 330 | — |
| 15 (Comparison) | — | 100 | — | — | — | X | X | P | 270 | — |
| 16 | — | 75 | 25 | X | X | — | — | K | — | 24 |
| 17 | — | 75 | 25 | X (80%) | X | — | X (20%) | K | — | 22 |
| 18 (Comparison) | — | 75 | 25 | X | — | — | X | K | — | 33 |
| 19 (Comparison) | — | 75 | 25 | — | X | X | — | K | — | 27 |
| 20 (Comparison) | — | 75 | 25 | — | — | X | X | K | — | 31 |

In the column “Metrastat test”, the product is all the better the higher the value.
In the column YI, the product is all the better the lower the value.

1. Graft rubbers stabilized to degradation by thermal oxidation, characterized in that they contain
a) at least one phenolic compound A) having at least one structural unit of the general formula I 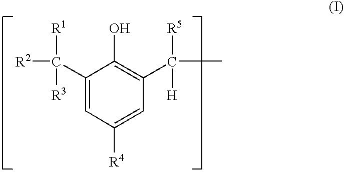
where
R¹, R², R³, R⁴ are identical or different and are an optionally substituted hydrocarbon radical having 1 to 20 carbon atoms,
R⁵ is an optionally substituted hydrocarbon radical having 1 to 20 carbon atoms or, together with the radical of compound A, forms an optionally substituted carbocyclic radical and
b) at least one sulphur-containing synergistic agent B) obtainable by polymerization of optionally substituted styrene with optionally substituted acrylonitrile and a mercaptan HSR⁶; preferably a compound B) having at least one structural unit of the general formula II 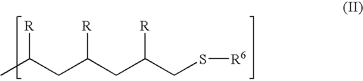
where
R are identical or different and are C₆H5, —CN or a substituted aryl radical
R⁶ are identical or different and are an optionally substituted hydrocarbon radical having 1 to 20 carbon atoms.

2. Graft rubbers according to claim 1, characterized in that 5 to 30% by weight (based on amount by weight of A) of a phenolic compound A1) having at least one structural unit of the general formula III 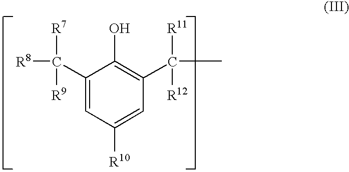
where
R⁷, R⁸, R⁹, R¹¹, R¹² are identical or different and are an optionally substituted hydrocarbon radical having 1 to 20 carbon atoms,
R¹⁰ is an organic radical, preferably a hydrocarbon radical having 1 to 10 carbon atoms,
is additionally present.

3. Graft rubbers according to claim 1, characterized in that 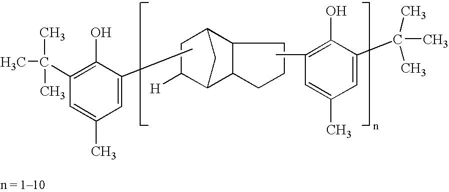
is present as phenolic compound A).

4. Graft rubbers according to claim 1, characterized in that a product of styrene, acrylonitrile and tert-dodecyl mercaptan having a sulphur content of 1 to 3% by weight, obtained by emulsion polymerization, is present as compound B).

5. Graft rubbers according to claim 1, characterized in that 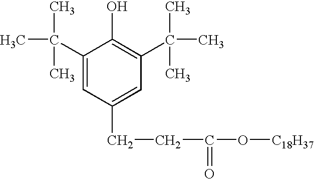
is present as compound A1).

6. Process for the preparation of dried graft rubbers stabilized to degradation by thermal oxidation, characterized in that a phenolic compound A) according to claim 1, present in aqueous emulsion or dispersion form, and a synergistic agent B) according to claim 1, present in aqueous emulsion, are added to the graft rubber present in the emulsion form, before the working-up and drying by a fluid-bed dryer, fluidized-bed dryer, pneumatic dryer or kneader reactors with stirring.

7. Impact-modified thermoplastic moulding materials, containing graft rubber according to claim 1.
